(19) United States
(12) Patent Application Publication
(10) Pub. No.: US 2008/0136900 A1
(43) Pub. Date: Jun. 12, 2008

(54) Method for the Autostereoscopic Representation of a Stereoscopic Image Original Which is Displayed on a Display Means

(76) Inventor: Armin Grasnick, Jena (DE)

Correspondence Address: BODNER & O'ROURKE, LLP, 425 BROADHOLLOW ROAD, SUITE 108, MELVILLE, NY, 11747, US

(21) Appl. No.: 11/660,610

(22) PCT Filed: Jul. 28, 2005
(86) PCT No.: PCT/EP05/08172

§ 371 Date: Oct. 9, 2007

(30) Foreign Application Priority Data
Aug. 25, 2004 (DE) 10 2004 041 052.6
Mar. 2, 2005 (DE) 10 2005 009 444.9

(51) Int. Cl. H04N 13/04

(52) U.S. Cl. 348/51; 348/E13.075

(57) ABSTRACT

The invention relates to a method for the autostereoscopic representation of a stereoscopic original image displayed on a display unit. Said method is characterized in that individual perspective views of the stereoscopic original image are selectively allocated to perspective-dependent display structures and an autostereoscopic representation of the image is generated based on an intrinsic perspective-dependent luminance (L) of a series of activated display elements, particularly individual pixels (P), subpixels (SP), pixel groups (PG), and/or similar other perspective-dependent display structures, said luminance (L) being generated by a display unit and being measured by an image analyzing unit.

The invention relates to a method for the autostereoscopic representation of a stereoscopic image original which is displayed on a display means, in accordance with the preamble of claim 1.

Methods and devices for generating and displaying stereoscopic image originals on display means are known and form an extensive prior art. In order to generate the stereoscopic image originals, especially in order to separate the image data for at least two observation perspectives, the image data is recorded in perspective-dependent manner. The data is then separately transmitted to the left eye and to the right eye by means of suitable display methods. A large number of methods already exist for the purpose. It is possible for the purpose, for example, to utilise the polarisation of light by using polarising spectacles, or polarisation arrays on the display surface and similar methods.

In applications in the field of display technology, there are used for the purpose, inter alia, polarisation arrays which modify, either actively or passively, the polarisation state, especially the polarisation direction of the light emitted by the image points of the display, in such a way that the image points in question can be recognised either by the left eye or by the right eye by means of analyser spectacles. By that means, for example, two image data items, one transmitted a short time after the other, are differently polarised one after the other and are therefore separately perceived although they then merge in the perception of the viewer into an overall spatial impression.

The provision of a polarisation array having unchangeable different final polarisation directions, for example by means of special LC displays, is technically very onerous and therefore is associated with high manufacturing costs. These circumstances prevent widespread use of a method of such a kind.

According to the prior art, shutter methods, especially using shutter spectacles, are also customary for binocular separation of the image information. However, these methods are suitable only in the case of displays having image repetition rates of at least 100 Hz upwards and are not practical for LC displays, which operate with substantially lower repetition rates.

The use of anaglyph spectacles, which is also known in the prior art, where differently colour-coded image data items are made available to the eyes of the viewer in binocular manner by means of the screening-out action of colour filters, falsifies the colour reproduction and makes true full-colour representation of the displayed image item difficult or impossible.

The use of lens, barrier or illumination systems in the case of given displays, which is known in the prior art, is necessarily associated with an enormous degree of intervention in the display technology and causes a reduction in the resulting resolution and/or image brightness. The resulting resolution is indirectly proportional to the number of perspective views arranged laterally next to one another, the so-called number of lateral perspectives, and is naturally greatest when two perspective views are used. The additional use of further lateral perspective views accordingly causes a further resolution reduction of the native resolution of the display.

However, the orthoscopic viewing space, that is to say the space of all possible viewing angles from which the viewer in front of the displayed stereoscopic image original can perceive a correct spatial impression of the image, is directly dependent on the number of lateral perspectives. If the number of perspectives is reduced, the resolution of the spatial representation is increased, whilst the orthoscopic viewing space is restricted.

In the case of a number of lateral perspectives of n =2 upwards, the maximum lateral freedom of movement B in the orthoscopic viewing space under ideal conditions is calculated by the relation B=(n−1)*A, wherein A is the spacing of the eyes. An increase in the freedom of movement is accordingly possible only by means of an increase in the spacing of the eyes or by means of an increase in the number of perspectives. Because the spacing of the eyes is anatomically predetermined and therefore practically incapable of modification, only increasing the number of perspectives accordingly remains for increasing the freedom of movement, which, as mentioned hereinbefore, is associated with a reduction in the resulting resolution.

The problem of the invention is accordingly to provide a method for autostereoscopic image representation which is suitable for display means, especially for flat displays, for example LCD, plasma or OLED displays, or displays for which the methods known in the prior art cannot be used or can be used only to a very limited extent, wherein no further loss of resolution occurs especially even in the case of an increased number of perspectives or by means of which the number of perspectives of an existing system can be increased without reduction of resolution. The method should moreover make possible substantially distortion-free and true-colour image reproduction and be implementable at reasonable cost for conventional displays.

The problem is solved by a method, for the autostereoscopic representation of a stereoscopic image original which is displayed on a display means, having the features of claim 1, the subordinate claims containing at least desirable and/or advantageous extensions to or embodiments of the method.

In accordance with the invention, the method is characterised in that on the basis of an intrinsic, perspective-dependent luminance—caused by the display means and measured by a display analysis unit—of a number of activated display elements, in particular individual pixels, sub-pixels, pixel groups and/or similar further perspective-dependent display patterns, a selective assignment of individual perspective views of the stereoscopic image original is performed and an autostereoscopic image representation is generated.

The method utilises the basically disadvantageous property of certain display techniques, that their luminance is, for technical reasons, in no way isotropic for all viewing angles but is subject to a clear directional characteristic which varies with distance and/or viewing angle. Certain excited portions of the display, for example pixels, pixel groups etc., are perceived from different perspectives as being of different brightness or as having a different colour. An example of extreme directional dependence of image representation is the process known in LC displays as the “flip-over effect”, wherein from a particular perspective that departs markedly from the orthogonal perspective the entire image suddenly appears in negative form. Other directional dependencies also occur in the case of other display techniques, for example as a result of manufacturing tolerances, anisotropic illumination or emission, a lack of homogeneity in materials, micro-deformation of surfaces, especially in the case of glass displays, variations in layer thicknesses, non-uniform absorption, scatter, diffraction, refraction or reflection. The light-emitting diodes of portions of the display accordingly have different values in dependence on the viewing angle or the distance from the viewer.

The basic idea of the method is accordingly to utilise this anisotropic disadvantageous luminance characteristic for the purpose of so displaying perspective views starting from a given stereoscopic image original that, by virtue of the perspective-dependent luminance characteristic of the display, each eye of the viewer is provided with a different perspective view of the stereoscopic image original. In the process, one eye of the viewer perceives, by virtue of the anisotropic luminance, only display constituents which belong to a first perspective view, whereas the other eye perceives, also by virtue of the anisotropic luminance, only display constituents which belong to a second perspective view. Those different perspective views are combined in the mind of the viewer into a spatial image impression. As a result, a spatial image accordingly appears on the conventional display without the display needing to be modified or arranged in a particular manner for the purpose.

The perspective-dependent luminance of the activated display element is determined in advance by an image analysis unit from a number of different observation positions, in particular different distances between the image analysis unit and the display, and/or different observation angles, the display element being assigned a distance-dependent and/or angle-dependent luminance indicatrix.

The luminance indicatrix indicates, as a measurement result, the angle-dependent and/or distance-dependent luminance values of the corresponding display component and constitutes an advantageous and readily analysed reference and evaluation possibility for the luminance values of the display component ascertained by the display analysis unit. As a result, for each display component, that is to say in principle for each pixel or sub-pixel, its angle-dependent and/or distance-dependent luminance is known so that assignment of each display component to one or more perspective views of the stereoscopic image original is possible in unambiguous manner.

The luminance indicatrix can be ascertained in various ways. In a first embodiment, the luminance indicatrix of the display component is determined in serial manner. In this case, the display component is selected by the display and at least one camera is moved in a defined manner across the area of the display surface and a series of perspective-dependent luminances of the selected display component are time-sequentially registered.

Accordingly, in that embodiment, the luminance indicatrix of the display component is obtained by means of a scanning procedure of a camera moved mechanically over the image item, in the course of which the luminance measured at a particular point in time is continuously stored, together with the position of the observation angle at that time during the movement, the spacing between the camera device and image item at that time and the display component selected at that time, and is assigned to the display component.

In a further embodiment, the luminance indicatrix of the display component is determined in a parallel manner. In this case, the display component is activated, with a camera array registering essentially simultaneously a series of perspective-dependent luminances of the display component that is currently active.

In that embodiment, the luminance indicatrix is obtained by means of the individual luminance values in each camera on the array, the individual observation angles relative to the activated display component being known for each camera. In this embodiment too, the luminance indicatrix ascertained in that manner is assigned to the display component concerned.

The serial luminance measurement has the advantage of a relatively simple camera arrangement having only one camera but it does require a movement mechanism having an inertia and an adjustment time which are as low as possible and having a comparatively high precision of adjustment. The parallel luminance measurement allows relatively rapid determination of the luminance indicatrix in a stationary camera arrangement.

Of course, in a further embodiment the luminance indicatrix of the display component can be determined in a combined manner both parallel and serially.

An entire set of luminance indicatrices is measured for each display component and stored in a storage unit. As a result, for each display component there is available a uniquely determined luminance indicatrix, which, as a display-characterising data set, forms the basis for further method steps.

In a further method step, image portions of the perspective views of the three-dimensional image original are assigned display portions with portion-wise corresponding perspective-dependent luminance indicatrices and displayed by those display portions.

As a result, the graphical courses of the luminance indicatrices determine which perspective view of the stereoscopic image original is to be assigned and displayed on which display portion. A display portion whose luminance indicatrix has, for example, a maximum in a particular observation direction is accordingly assigned to a clear perspective view from the stereoscopic image original.

Advantageously, an assignment specification in the form of a combination table is generated by an assignment unit on the basis of the parameters of the measured luminance indicatrices, in particular their luminance and contrast ratios, viewing distances, observation angles, direction-dependent contrast, and similar values, with a parameter-dependent assignment of the display portions to the individual perspective views of the stereoscopic image original being established by means of the combination table and executed.

This makes it possible, on the one hand, to establish a series of selection and/or assignment criteria and, on the other hand, to continuously execute the assignment of the display portions concerned by means of the existing combination tables using algorithms, it being possible for the perspective views to be assigned to the display portions completely automatically.

In an advantageous embodiment, an entire set of measurement-position-dependent combination tables is managed, with it being possible for an adjustment to a changed viewing position to be made by selection of a suitable combination table. This means that the autostereoscopic image representation is not fixed exclusively for a particular distance between the viewer and the display but can, if required, also be adapted to at least one further position of the viewer.

This embodiment accordingly takes account of the fact that the assignment of a display portion to a particular perspective view changes in the event of a changed viewing position and accordingly has to be carried out differently. For the purpose, reference is made to the combination table which corresponds to that viewing position and, on the basis of that new combination table, the changed assignment between the display portions and the perspective views of the stereoscopic image original is carried out.

In an advantageous embodiment, the selection of the suitable combination table can be effected interactively, with the position of the observer, in particular his or her head and/or eye position, being detected and the detected position being converted into a selection parameter for the combination table.

The viewer can accordingly change his/her position relative to the image item, with that change in position being measured, whereupon there is obtained, from the new position that is then the case, a selection parameter which in turn brings about the activation of a particular combination table for that viewer position. In the process, the assignment between viewer position, selection parameter and combination table is carried out automatically, as a result of which it is made possible for the viewer to be able to correctly perceive the autostereoscopic image representation even from a different viewing position.

In conjunction with the described method steps and/or embodiments, an optional specification of a direction-selective element to at least one perspective view can be made, with the direction-dependent element being adapted to the pattern of the perspective view, in particular to its contour, partial sections with a certain display-specific inadequate contrast effect and/or to a given viewing position.

The direction-selective element serves the purpose of making possible a stereoscopic representation for particular components which occur in more than one perspective view. In the process, particular image portions or partial sections of the perspective views which really ought to be assigned to display portions whose luminance indicatrices do not exhibit a unique perspective dependency are assigned in part to other display portions having a more markedly patterned luminance indicatrix.

For display portions whose luminance indicatrices exhibit inadequate perspective dependencies, it is possible to generate a direction dependency by using an additional direction-selective element assigned to the respective display portion.

The mentioned perspective-dependent luminance can comprise either a brightness value of a display portion or a chromaticity of a display portion. Furthermore, the perspective-dependent luminance can comprise both the brightness value and also the perspective-dependent chromaticity of the display portion.

It is accordingly advantageous to ascertain, to evaluate and to utilise for the method the perspective-dependent display characteristic with respect to a parameter set which is as comprehensive as possible.

An arrangement for executing the method for the autostereoscopic representation of a stereoscopic image original which is displayed on a display means is characterised by at least the following system components:

The arrangement comprises at least one display unit with a distance-dependent and angle-dependent luminance characteristic, an image analysis unit for registering angle-dependent or distance-dependent luminance values of the display unit, a storage unit for measured luminance indicatrices, a comparator and assignment unit for the stored luminance indicatrices and image portions, and a storage unit for stereographic image originals.

In a first embodiment, the display analysis unit comprises at least one camera which is arranged at a defined distance from the display surface and movable between at least two given positions and which serially receives the light from a momentarily activated portion of the display.

In this case, the camera carries out movements between at least two locations and registers the luminance of a momentarily active portion of the display and so determines the luminance indicatrix of that momentarily active display portion in perspective-dependent manner.

In a further embodiment, the display unit consists of a camera array having at least two stationary cameras. As a result, luminance measurements of the particular display portion that is active can be made in parallel from at least two perspectives.

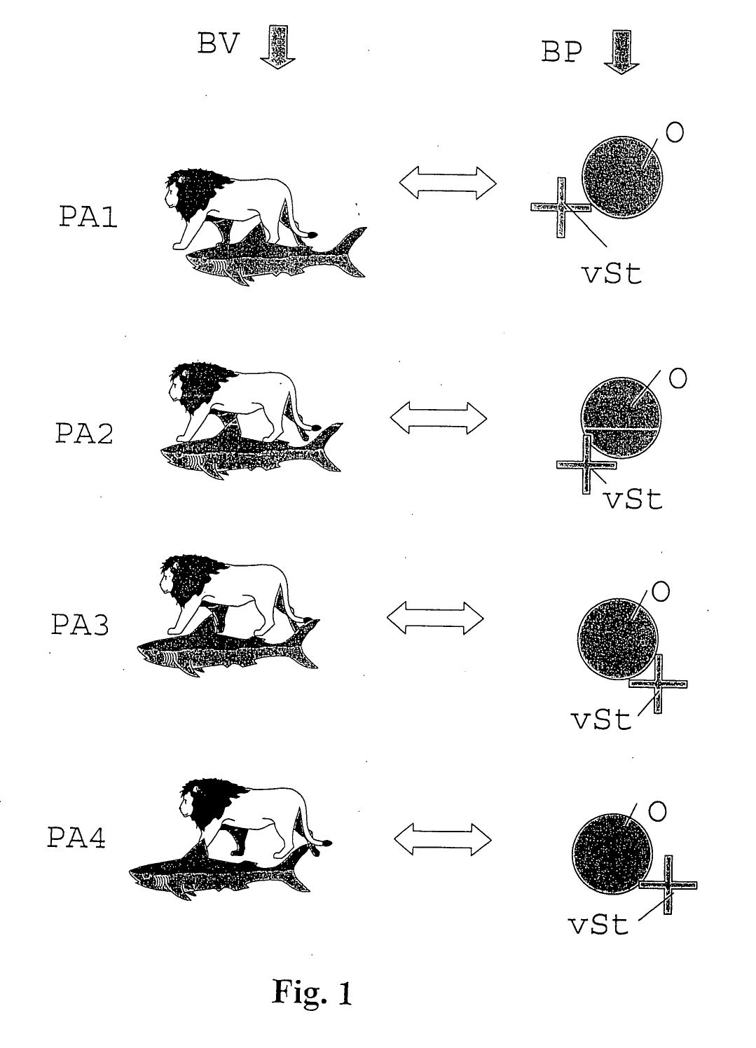

The method and the arrangement will now be explained in greater detail with reference to examples of embodiments. The same references are used for parts or method components that are the same or that have the same effect. The accompanying FIGS. 1 to 8 serve for clarification, wherein:

FIG. 1 shows, by way of example, a stereoscopic image original consisting of four perspective views,

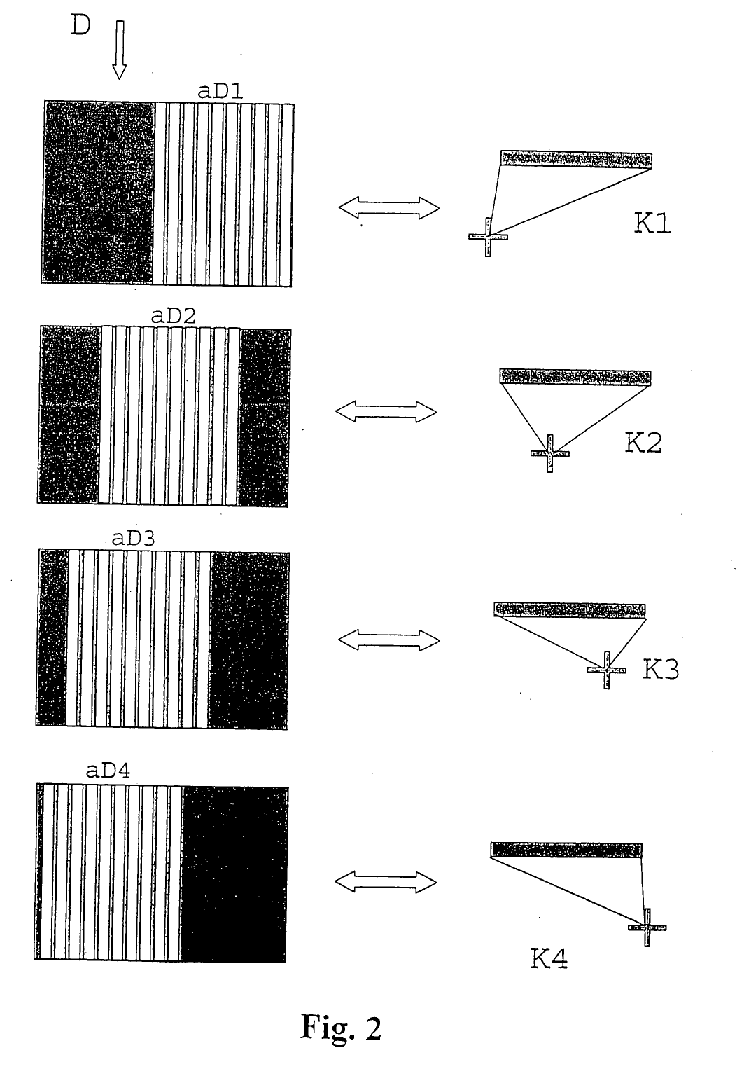

FIG. 2 shows, by way of example, an anisotropic luminance characteristic of a display,

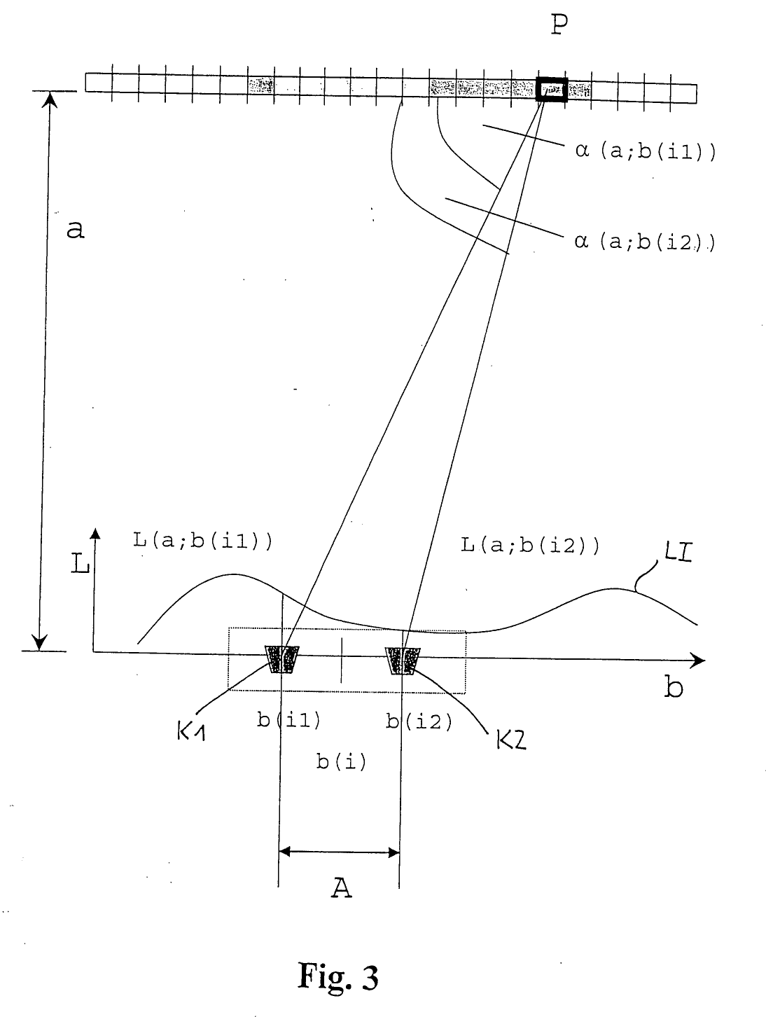

FIG. 3 shows, by way of example, display analysis in a first embodiment,

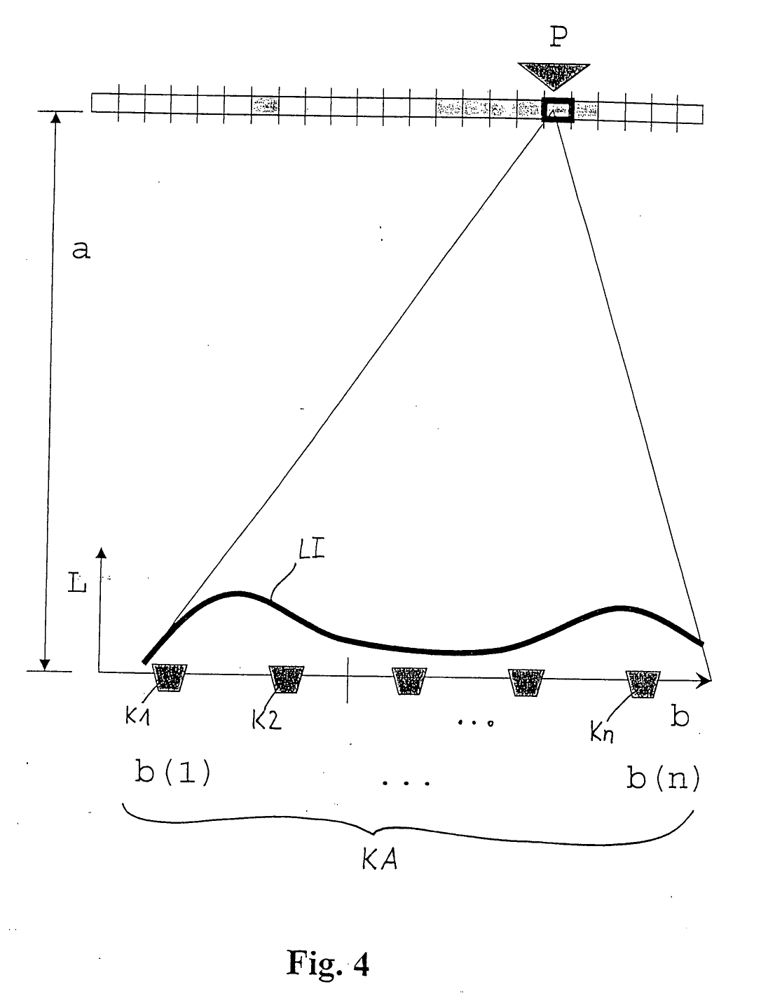

FIG. 4 shows, by way of example, display analysis in a second embodiment,

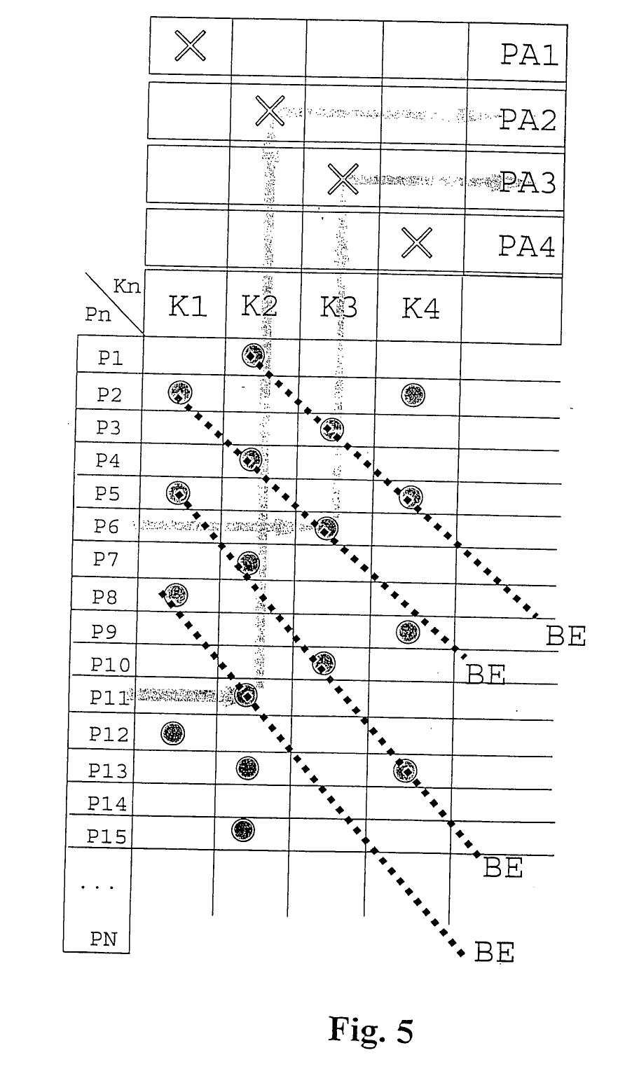

FIG. 5 shows, by way of example, a combination table,

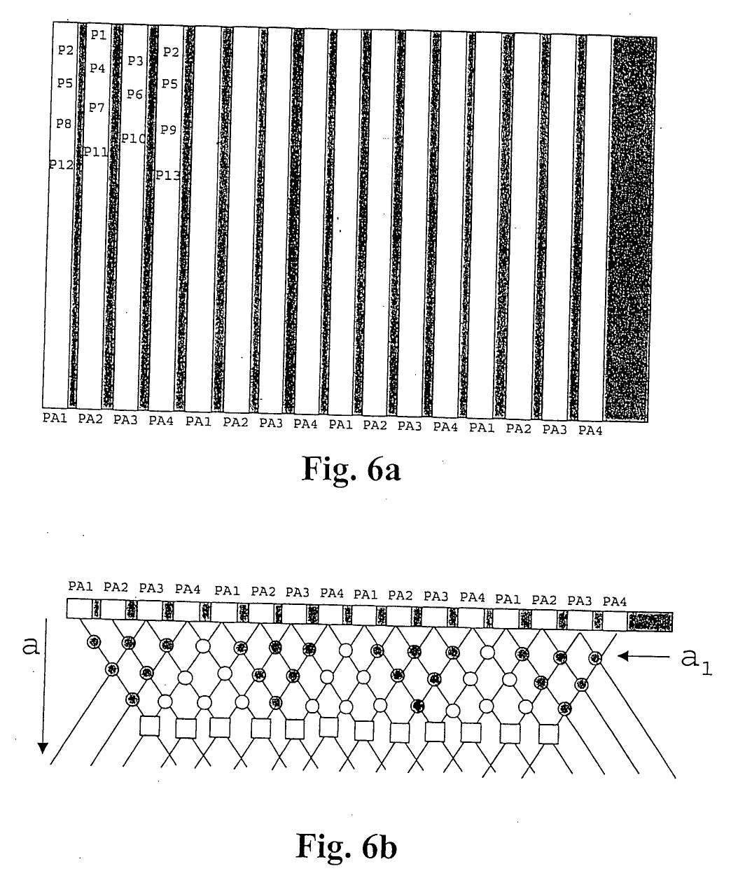

FIG. 6a shows, by way of example, assignment of a series of perspective views to an entire set of display portions,

FIG. 6b shows, in diagrammatic form, the orthoscopic viewing space formed by the assignment of FIG. 6a,

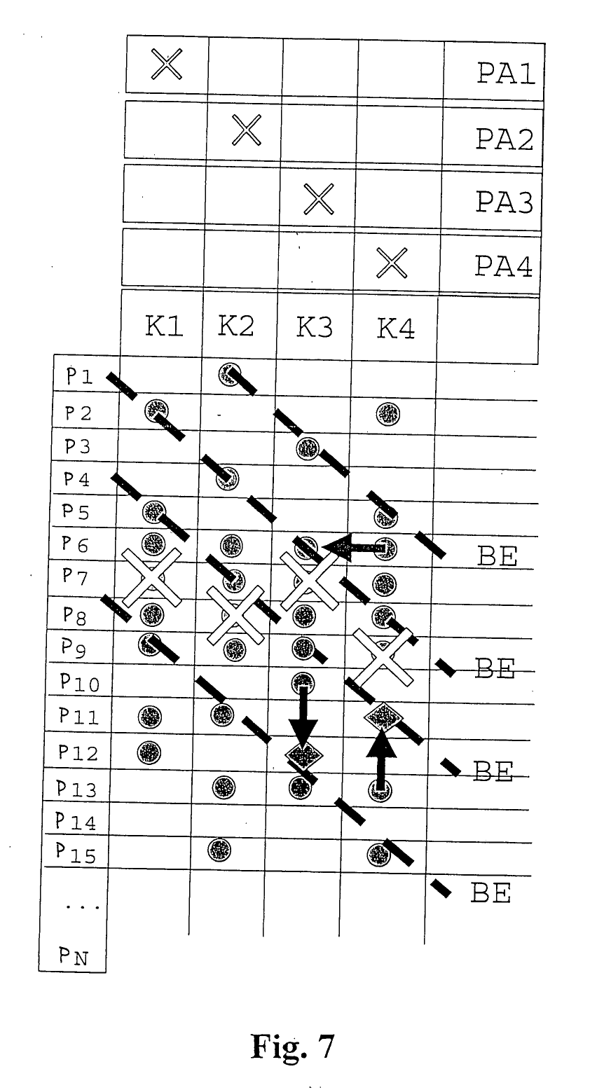

FIG. 7 shows, in diagrammatic form, a barrier-corrected combination table,

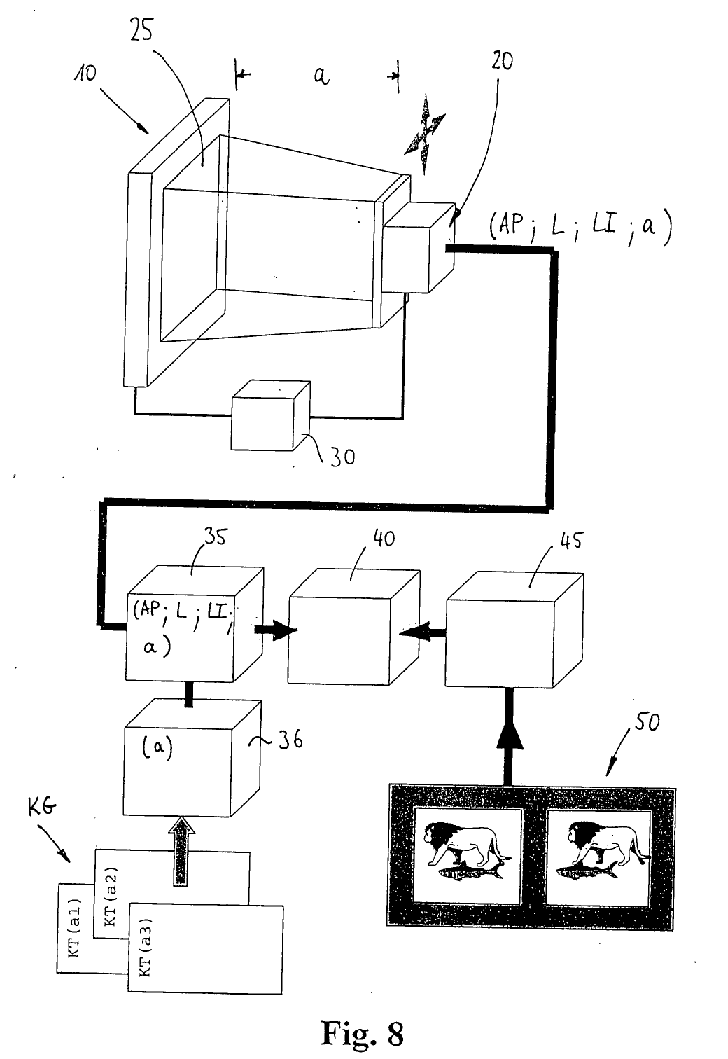

FIG. 8 shows, by way of example, an apparatus configuration for carrying out the method.

As is known from stereoscopic representation theory, at least two perspective views are required, which have to be suitably encoded and processed in such a manner that, using appropriate representation means, the two perspective views can be presented to each eye of the viewer separately. The two perspective views are merged in the mind of the viewer to form a stereoscopic image, that is to say an image giving an appearance of space. If more than two perspective views are used, in each case two perspective views from that entire set can be suitably combined, as a result of which different spatial image impressions are obtained. The entire set of the perspective views, optionally already appropriately prepared for the purpose, forms the stereoscopic image original. The description that follows is based on the premise of an already given stereoscopic image original. It is then shown by way of example how the given stereoscopic image original can be shown on a display which has an intrinsic anisotropic luminance characteristic so that a spatial image impression appears on the display.

FIG. 1 shows, by way of example, a stereoscopic image original BV, which consists of four perspective views PA1, PA2, PA3 and PA4. The perspective views are shown in picture form below one another in the left-hand column. The object O represented consists in this example of a shark in the foreground and a lion arranged behind it. At different locations vSt these are displaced relative to one another. The right-hand column shows, in diagrammatic form, the respective viewing positions BP associated therewith. The first perspective view PA1 corresponds in this case to a location on the left, perspective view PA2 to a central-left location, perspective view PA3 to a central-right location and perspective view PA4 to a location on the right.

FIG. 2 shows, in diagrammatic form, a display D having a very clear anisotropic luminance characteristic. Herein below when using the term “luminance” this will be understood as both the pure perspective-dependent brightness value of the display portion in the narrower sense and also its perspective-dependent chromaticity. Accordingly, measurement of the perspective-dependent luminance or luminance indicatrix equally describes a brightness value and a chromaticity measurement. These can be carried out in combination or separately and it is possible for either only brightness value measurements or only chromaticity measurements to be carried out. The appropriate procedure for the individual case will depend on the particular conditions of use that are present and that have to be taken into account.

When viewing the display controlled in otherwise defined manner, its pixels or sub-pixels appear, given a different perspective, of a different brightness and/or of a different colour. This anisotropic effect results from the particular technology used for the display and/or from the above-mentioned production-related irregularities.

For example, liquid crystal displays consist of a liquid crystalline layer encased in the manner of a sandwich between two transparent electrodes. The bottom and/or top surface of the liquid crystal layer, and/or the transparent electrodes, bring about a pre-orientation of the liquid crystalline order, which is either impermeable or transparent to light that is directed back in. As a result of excitation of the transparent electrodes, the internal molecular order of the liquid crystal layer is so re-oriented that the transparency of the liquid crystal layer is modified. The perspective-dependent luminance of the pixels results from the fact that the light of a pixel modified by the particular molecular order can basically be properly perceived only in a spatial direction or more or less restricted spatial region for which the length of the light path, the director orientation of the liquid crystal and the pass-through direction of the polarising covering surface agree precisely in such a manner that the pixel exhibits the requisite brightness value or chromaticity for the viewer. If the viewer is located outside that spatial region, the pixel appears dark or discoloured. Such an effect is found in such liquid crystal displays as the “flip-over effect”, where in a particular display position the brightness values of the pixels may under certain circumstances be so reversed for the viewer that the image shown appears in a negative representation. Cheap liquid crystal displays having a simple structure, which are used for example as colour displays for mobile telephones, show this actually undesirable effect extremely clearly.

In the case of luminescence displays, especially plasma displays, the anisotropic luminance effect is produced by the design of the luminescence cells. These consist in each case of a depression which holds a gas, which is excited by means of control electronics and excited to emit initially invisible luminescence radiation. The depressions are lined with a coating which converts the luminescence radiation emitted by the gas into visible light. As a result of the geometric form of the depressions, the visible light produced can be perceived from just one corresponding spatial region which is not hidden by the depth of the luminescence cell.

In the case of both display arrangements, the anisotropic luminance is accordingly not additionally brought about but is present owing to technical reasons and is therefore intrinsically present. It should be emphasised that it is not of importance to the method according to the invention and to the examples of embodiments hereinbelow how the anisotropic luminance effect comes about. Rather, the sole critical circumstance is that this effect does occur in the case of the display concerned, entirely irrespective of the specific technology of the display in question, and is detectable.

FIG. 2 shows this anisotropic luminance effect in diagrammatic form. In the left-hand column of the Figure there is shown a sequence of different views of a display D and the display portion aD1, aD2, aD3, aD4 etc. that can be perceived in the case of the respective view concerned. In the right-hand column of the Figure these are related to the associated camera positions K1, K2, K3 and K4. The Figure shows that from camera position K1 there can be recognised a display portion aD1 which is located on the right-hand side, which changes to the positions aD2 and aD3 in the case of camera positions K2 and K3, until in the case of camera position K4 only a display portion aD4 arranged to the left-hand side is recognisable. The diagrammatic display here would accordingly, in the case of binocular frontal viewing, show only the combination of the display portions aD2 and aD3. In the case of the monocular camera positions K1-K4, the perceptible display portions are each individually restricted to the portions aD1-aD4.

The method according to the invention is essentially directed at assigning various perspective views Pn of the given stereoscopic image original BV to the respective display portions aDn recognisable at particular camera positions Kn. In this case, the right eye of the viewer perceives a first perspective view and the left eye a second perspective view and there is formed on the display a spatial image impression.

Depending on the display type, different numbers of individual perspective views can be represented. For the purpose, the anisotropic luminance characteristic of each individual pixel must be known or determined beforehand. The particular perspective views can then be subsequently allocated to the pixels measured in such a manner.

Hereinbelow, with reference to FIGS. 3 and 4, there will first be described the method step for determination of the anisotropic display characteristic. For reasons of simplicity, this method step will be shown by way of example by means of analysis of one display line and especially one individual pixel P. It will be clear that this kind of information processing and image processing is to be carried for each display line and each pixel or the corresponding display portion. FIG. 3 shows an example of simple binocular luminance detection using an initially stationary camera installation, installed in a fixed manner, comprising two cameras; FIG. 4 shows an improved variant of luminance detection using a camera array comprising n cameras.

FIG. 3 makes clear a number of fundamental method steps and process variables. In the Figure there is shown, by way of example, a display line DZ, with a pixel P being activated in defined manner at the particular moment in this example. At a distance a there is located an arrangement K comprising individual cameras K1 and K2, which are arranged on a path b oriented substantially parallel to the display line DZ. The location of the cameras therein is clearly determined by definition of the distance a between the display line DZ and the path b and by the position b(i) of the camera arrangement as a whole. The cameras themselves are located at the positions b(i1) and b(i2) at a spacing A relative to one another. This can correspond especially to the natural spacing of the eyes. Using an especially simple arrangement of such a kind it is possible to find at least two perspectives, at which the display, or portions and pixels thereof, appear(s) with a different luminance relative to the respective camera location. In this case, accordingly, allocation of two perspective views to the pixels of the display would be possible.

The activated pixel P has an anisotropic luminance characteristic caused by technical reasons of the display and dependent on the distance a and the positions on the path b. Given a fixed distance a, the luminance L generated by the pixel P varies only along the path b and accordingly as a good approximation depends only on the detection angles α(a;b(i1)) and α(a;(b(i2)). The luminance L along the path b, which is accordingly substantially only angle-dependent, is denoted by the luminance indicatrix LI. Each point of the luminance indicatrix describes the luminance dependent on the position of the camera arrangement. In the example of FIG. 2, this is the luminance, L(a;b(i1)) and L(a;b(i2) for each of the two cameras.

These luminance values are registered by both cameras K1 and K2 and accordingly from different viewpoints. In the example of FIG. 3, a combined registration produced by serial and parallel measurement value detection is also possible. This is accomplished by means of the fact that the cameras K1 and K2 are not mounted in a stationary position but rather are mechanically moved initially as an entity in the form of the camera arrangement K along the path b to a series of positions of defined points b(i), where the luminances L(a; b(i1)) and L(a; b(i2)) are measured substantially simultaneously. This procedure for detection of the luminances accordingly mimics a lateral movement of a viewer having the eye spacing A relative to the display line, that is to say especially relative to the active pixel P. A serial luminance detection of the pixel of such a kind can of course also be carried out by means of a single camera, which is moved on the path b in steps of basically any desired magnitude.

As a result of that luminance detection, the luminance indicatrix LI is registered point-wise, that is to say in dependence on the changing positions of the cameras K1 and K2, and stored. The detection of the luminances is advantageously synchronised with an image repetition rate of the display so that the registered luminance indicatrix LI is clearly assigned to the pixel P. As an alternative thereto, the display can of course also be selected in defined manner by means of measurement software, in which case the particular selected pixel is defined and known in terms of its location, brightness and/or chromaticity parameters. It will be understood that, depending on the aperture angle of the cameras K1 and K2, image components larger or smaller than the active pixel P can also be detected. In the case of the desired selection of the pixel this does not in principle constitute a problem. The camera does not necessarily have to detect the pixel as an image, but rather an intensity measurement of the pixel by the camera is sufficient. Provided that the display together with the camera device is located within a darkened spatial region separated off from the surroundings, the selected pixel forms the sole light source for the camera arrangement and the aperture angle of the camera can therefore be disregarded.

In the case of a free-standing arrangement of camera and display, the luminance detection by the cameras K1 and K2 should be suitably synchronised with the image repetition rate of the display so that all pixels from the area of an image portion which are given by the aperture angles of the cameras K1 and K2 are detected. A solution thereto can be provided, for example, by means of the fact that the luminance indicatrices of each image portion detected by the cameras are continuously recorded and sorted, with the luminance indicatrix of each image portion being gradually completed as a result of the interplay of image repetition rate and camera movement.

For that reason, comprehensively parallel detection of the luminance indicatrix of an image portion, especially of the pixel P, is substantially more advantageous. FIG. 4 shows an example thereof. The camera arrangement in this case is in the form a stationary linear camera array KA arranged at a distance a relative to the display line DZ and comprising n substantially equidistant cameras at positions K1, K2, K3, . . . , Kn. The particular spacings between the camera positions K1 to Kn can correspond to average eye spacings. More advantageous, however, is a camera array in which the camera positions are whole-number fractions of the average human eye spacing, for example ½, ⅓, ¼ etc., or are sufficiently fine to mimic a certain variability in eye spacing. The active pixel P is detected substantially simultaneously by all n cameras of the array from the corresponding n camera perspectives, with the luminance indicatrix LI of the pixel P being immediately output and stored. In the case of this procedure, the luminance measurement by the camera array KA is most advantageously synchronised with the scanning rate of each pixel P or the pixel is selected in desired manner by means of measurement software, in which case its properties, especially brightness value and chromaticity, can be objectively specified.

The camera array KA can be both in the form of a one-dimensional linear array and in the form of a two-dimensional array. An area array allows registration of a spatial luminance indicatrix for the pixel or for each display portion and provides additional indicatrix information but provides substantially no advantage with respect to the number of perspectives because the stereographic image original always has to be adapted to the natural linear eye arrangement of the viewer. In the case of an area array, however, the vertical array columns belonging to the individual camera positions K1 to Kn can be connected to form a camera column, with it being possible for each individual camera from that column to detect the luminance of a pixel on the display from a distance that is as small as possible and in a direction that is as horizontal as possible.

As mentioned, the cameras of FIGS. 3 and 4 basically need only to carry out luminance measurement and do not necessarily need to be of an image-producing form. As a result, the amount of data to be detected and the camera specifications are greatly reduced.

As a result of the display analysis carried out in that manner, a luminance indicatrix is assigned to each individual pixel. The indicatrix consists of luminance values assigned point-wise to the individual camera perspectives K1 to Kn. The luminance indicatrices generally have for each pixel at a particular camera position Kn at least one maximum luminance value, whereas the pixel does not appear or appears only weakly at all the other camera positions. Consequently, the pixel can be assigned to that camera position and also, as a result, to a particular perspective view. This assignment can be illustrated, implemented and stored by means of a combination table.

FIG. 5 shows, by way of example, a combination table. The left-hand column Pn contains all the pixels of the measured display, having consecutive numbers from P1 to PN. The numbering is, in principle, arbitrary and can be modified as desired as part of advantageous arrangements. A header Kn contains all camera positions K1 to Kn used during the display analysis. In the example shown here, there are four camera positions K1 to K4. The table area generated by the Kn line and the Pn column shows the positions of the maxima of the measured luminance indicatrices of each pixel Pn and the assignments resulting therefrom. For example, the luminance indicatrix of the pixel P1 has a maximum at the camera position K2. It is also possible for a pixel to exhibit a plurality of maxima. For example, the pixel P5 has a luminance maximum both at the camera position K1 and also at the camera position K4. The combination table of FIG. 5 shows that, in this example, the. luminance maxima assigned to the particular pixels and camera positions exhibit a periodic behaviour. Under those conditions it is clear for this individual case that various perspective views PAn, for example the perspective views of FIG. 1, should be assigned to the individual camera positions Kn and, therefore, the pixels Pn. In the combination table of FIG. 5 this example of an assignment specification is plotted at the top by means of the table area generated by the Kn line and a PA column. It can be seen that, in this example, the camera position K1 is clearly assigned to the perspective view PA1, the camera position K2 to the perspective view PA2 etc. As a result it is also established that in this case, for example, the pixels P3, P5, P8 and P12 belonging to the camera position K1 are to be assigned to the perspective view PA1, whereas, for example, pixel P6 becomes a component of the perspective view PA3 and pixel P11 a component of the perspective view PA2.

FIG. 6a makes this assignment clear using a diagrammatic display. The display is in this case divided into columns, the column pattern having been ascertained as a result of the display analysis described above. As a result of the assignment, shown in FIG. 5, between the camera positions K1 to K4 and the perspective views PA1 to PA4, the columns shown in FIG. 6a correspond in each case to the perspective views PA1 to PA4. From FIG. 6a it can be seen that in this case the sequence of the perspective views PA1 to PA4 is periodic so that the entire display area is in this case made up of a periodic sequence of columns. The pixel numbering known from the combination table in FIG. 5 is entered on FIG. 6a. It will be seen that the column of the perspective view PA1 is occupied by the pixels P2, P5, P8 and P12. The following column of perspective view PA2 results from the pixels P1, P4, P7 and P11, whereas the subsequent columns are structured in a corresponding manner. Here too the pixel numbering is arbitrary and relates exclusively to the combination table of FIG. 5 and serves exclusively for the purpose of describing the method as simply as possible. In the context of actual use on a display having, for example, 1024×768 image points it will of course be advantageous to carry out the pixel numbering differently. Advantageously, the pixels of the first display line will be completely through-numbered and then the numbering continued with the pixels of the second display line. Of course, a different form of pixel identification or addressing will also be possible or under certain circumstances absolutely necessary, for example by means of a two-digit indexing system.

FIG. 6b shows, in diagrammatic form, the orthoscopic viewing space resulting from such a division with four perspective views. The orthoscopic viewing space is the set of all points from which, in the case of binocular viewing of the display, two perspective views in each case can be perceived in the correct sequence. In FIG. 6b, these points are shown as filled-in circles. The non-filled-in circles mark so-called pseudoscopic points, where two perspective views in each case are perceived in an incorrect position relative to one another. For the sake of completeness, locations are marked by means of non-filled-in squares in FIG. 6b from which identical perspective views in each case are seen both by the left eye and by the right eye, that is to say where stereoscopic viewing is not possible.

In general, it is only the locations situated at a minimum distance a₁ relative to the display that have to be taken into account as points of the orthoscopic viewing space, at which locations two directly adjacent perspective views in each case, for example the perspective views PA1 and PA2, or PA2 and PA3, or PA3 and PA4, can be perceived at the same time and in the correct position relative to one another. The distance a₁ then denotes the advantageous viewing distance of the viewer relative to the display. As can be seen from FIG. 6b, multiple orthoscopic locations are present at the distance a₁. Advantageously, the previously described display analysis is carried out using a camera arrangement at that viewing distance a₁ and the method is to a certain extent calibrated to that viewing distance a₁. As the viewing distance there can be selected, for example, the usual reading distance of a viewer relative to a display of given size. For computer monitors or flat displays with the usual screen diagonals of 17 to 22 inches, a₁ is, for example, 30 to 50 cm. Larger displays, for example large screens, accordingly require a distance a₁ in the range from at least 2 metres, preferably 5 to 10 metres.

It is to be noted that combinations of individual pixels can also be made to form pixel groups which meet the criterion of a maximum of corresponding luminance indicatrices which has substantially the same location. In this case, these pixel groups form specific sub-units for the assignment of individual perspective views or their details. It is also possible for pixels to be grouped together into one or more pixel groups on the basis of other criteria, for example pixels whose luminance indicatrices have maxima principally at the edges of the path b shown in FIG. 4 or pixels whose luminance indicatrices have substantially no maximum. The pixel group formed by way of example in such a manner can be assigned to the perspective views by a differently constructed specific combination table in a manner that is different therefrom. The assignment specification for generating the combination table and the corresponding combination table itself is accordingly variable in almost any desired manner, it being possible by that means to take into account display characteristics.

The combination table is substantially dependent on the measurement position during display analysis, especially on the particular viewing distance used. Strictly speaking, a separate combination table corresponds to each measurement position or viewing position a. In the example of FIG. 5 and the example of FIGS. 6a and 6b derived therefrom, this is the combination table KT(a₁) for the distance a₁ relative to the display. This combination table can be supplemented by at least one further combination table, by repeating the display analysis at at least one further, greater or lesser, distance aₓ and carrying out the assignment of the measured pixels or pixel groups to the perspective views anew in a manner corresponding thereto. As a result of software selection of a particular previously stored combination table and a newly carried out assignment of pixels and perspective views, the display, having been set up for the defined first viewing distance a₁, can be adapted to the at least one further viewing distance aₓ. This can also be carried out interactively by measuring the head and eye position of the viewer.

The assignment information contained in the combination table of FIG. 5 can optionally be modified, especially corrected. In the process, the modification or correction can be carried out both from the direction of the perspective views PA1 to PA4 to be displayed and have an effect on the set of pixels P1 to PN or it can start from the set of measured pixels P1 to PN and have an effect on, and modify, the perspective views PA1 to PA4. In the first case, certain properties of the perspective views or of the stereoscopic image to be represented can be taken into account, corrected or modified. In the second case, certain irregularities or individual properties of the display can be adapted to the perspective views present. In both cases, these corrections or modifications are performed by re-distributing, shifting, deleting or newly setting the assignment points at the Kn/Pn level of the table. By that means it is possible, especially, for advantageous compromises to be reached between the properties of the display and of the stereoscopic image original. In this connection, direction-selective logic elements play a key part.

FIG. 7 shows a further combination table, by way of example, having a relatively large amount of irregular and, therefore, disadvantageous assignment points at the Kn/Pn assignment level. The assignment table shown in FIG. 7 can be seen as an irregular version of the assignment table of FIG. 5. In the combination table of FIG. 5 it is noticeable that the assignment points substantially group together along diagonal lines. These lines are substantially due to the technical characteristics of the measured display. They accordingly represent an intrinsic, technically related disparation function of the display. The more clearly such patterns stand out or can be found within the combination table, the more suitable is the display for the representation of a stereoscopic image original in accordance with the invention.

The correction and modification method of the combination table of FIG. 7 is based then on the idea firstly of finding or identifying such intrinsic direction-selective patterns and secondly of so re-grouping the assignment points at the Kn/Pn level that these direction-selective patterns are optimally reproduced or reinforced. In the combination table of FIG. 7 direction-selective elements BE, by way of example, have already been identified in an assignment set. For the purpose of identification of those patterns it is possible to use the customary mathematical regression or analysis methods, especially linear regressions or Fourier analyses. Unlike the barrier patterns known from the prior art, such disparative patterns, which are either intrinsically predetermined or introduced subsequently, do not reduce the image brightness, because they either arise from the characteristics of the prespecified and uninfluenced display or are produced from mere re-sorting of given assignments at the Kn/Pn level.

In FIG. 7, the luminance variance, for example of the pixel set comprising the pixels P6 to P9 or of the display portion formed thereby opposite the camera positions K1 to K4 is too low, or the pixels concerned form identical portions of the perspective views PA1 to PA4. In the case shown here, by means of appropriate specification of the assignment of pixels and camera positions and consequently the viewing position or perspective views, the intention is to cause a direction-selective element to be assigned in an as unambiguous a manner as possible to in principle each pixel or pixel group. Unlike barrier systems known from the prior art and produced in the form of hardware, the direction-selective elements used here can be assigned without any problem to optionally just a small group compared to the entire set of pixels, or even to individual pixels or even sub-pixels. It is optionally possible, without any problem, for regions which do have sufficient luminance variance to be excluded from coverage by a direction-selective element. It will be understood that the specific direction-selective element is in principle always adapted to a specific monitor, a specific display or the like or measurement values thereof, where no overall display characteristics associated with a certain display technology or production series can be identified. Accordingly, a method of setting the barrier elements that is economical in the case of single unit numbers, that is to say individual displays, is advantageous.

In the case of the method carried out in the combination table in FIG. 7, different assignment points close to or at the direction-selective elements BE are collected at least in particular areas. This can be accomplished by means of shifts in any desired direction per se or by deletions of assignment points. Accordingly, for example, the assignment point K4;P6 is removed from its original position in the combination table and shifted along a line to the position K3;P6. If there is already an assignment point at that location, this shifting is equivalent to deletion of the original assignment. With regard to the autostereoscopic representation on the display, this means that part of one perspective view is transferred to a different perspective view.

Within-column shifts are carried out, for example at the assignment points K3;P10 or K4;P13. For the autostereoscopic representation on the display this means, in the final analysis, that an image component is shifted within a perspective view. A series of assignment points, for example the assignment points K1;P7 or K2;P8, are deleted and they disappear from the corresponding perspective views, with for example those pixels being shown black or in a neutral background colour on the display. This operation results in a certain loss of resolution of the perspective views.

All those operations can be carried out to an in some cases considerable extent if the display contains a sufficiently high number of pixels. Physiologically, resolution losses are disregarded by the perception apparatus of the viewer as a result of the continuing overall impression of the image and are not consciously perceived or are unconsciously supplemented. An approximate rule of thumb for corrections within the assignment table accordingly holds that it is possible to improve the quality of the representation of the autostereoscopic image on the display more consistently by using very many deletion or shift operations which are however in individual cases as small as possible than by using a few corrections which are however very large. It is therefore possible in principle for each of those small optimisation operations to be formalised by basically very simple algorithms, in which case the superordinate image information, that is to say the image item, does not need to play a part.

FIG. 8 shows an arrangement by way of example for carrying out the previously described method steps. In front of a display 10, which can be especially an LC display, there is located, at an in the first instance constant distance a, a display analysis device 20, which is associated by means of a synchronisation device 30 with the selection of the display. The image analysis device carries out the measurements of the luminance indicatrices in accordance with the previously described method steps. In addition thereto, the display analysis device 20 can include a distance measurement device for determination of the distance a, which device outputs a distance parameter AP. The measurement data supplied by the image analysis device 20 is transmitted to a storage unit 35, which stores both the luminance indicatrices LI and also the location of the activated pixel or display portion and assigns each location to the luminance indicatrices LI. The storage unit 35 is furthermore connected to a selection unit 36, which especially selects from an existing entire set KG of stored combination tables KT(a1), KT(a2), KT(a3) etc. the combination table corresponding to the particular distance a. The luminance indicatrices LI and selected combination table KT are passed to a comparator and assignment unit 40. A storage unit 45 for a stereoscopic image original 50 makes available the image information for generation of the autostereoscopic image.

In the example shown in FIG. 8, the display is analysed by the display analysis unit 20 in at least two perspectives, the pixel groups on the display 10 having different luminance characteristics from two perspectives. The already existing stereographic image original 50 consists in this case of two individual images. These are distributed by means of the assignment unit 40, using the luminance indicatrices—stored in the storage unit 35—and the selection unit 36 for the entire set of combination tables KG, to the pixels of the display in accordance with the afore-mentioned method steps. After completion of these operations, the image information prepared in that manner can be passed to the display and there appears on the display an autostereoscopic image reproduction of the stereoscopic image original.

### LIST OF REFERENCE SYMBOLS

10 Display unit
20 Display analysis unit
30 Synchronisation unit
35 Storage unit
40 Assignment unit
45 Storage unit for autostereoscopic image original
50 Stereoscopic image original
α Viewing angle
A Eye spacing, camera spacing
a Viewing distance
b Lateral path
BE Direction-selective element
DZ Display line
K Camera arrangement
KA Camera array
K1, K2, . . . , Kn Positions of individual cameras
KG Entire set of combination tables
KT Combination table
KT(a1), . . . , KT(a3) Distance-assigned combination table
L Luminance
LI Luminance indicatrix
M Local indicatrix maximum
P Pixel
PG Pixel group
SP Sub-pixel

What is claimed is:

1. A method for the autostereoscopic representation of a stereoscopic image original displayed on a display means, said method comprising:
on the basis of an intrinsic, perspective-dependent luminance which is caused by the display means and measured by an image analysis unit of a number of activated display elements, individual pixels, sub-pixels, pixel groups and/or similar further perspective-dependent display patterns,
the steps of:
performing a selective assignment of individual perspective views of the stereoscopic image original to the perspective-dependent display patterns; and
generating an autostereoscopic image representation.

2. The method according to claim 1, further comprising the step of determining the perspective-dependent intrinsic luminance of the activated display element in advance by an image analysis unit from a number of different criteria selected from the group consisting of observation positions, different distances between the image analysis unit and the display, different observation angles, and different distances between the image analysis unit and the display and different observation angles, with the display element being assigned a luminance indicatrix selected from the group consisting of a distance-dependent luminance indicatrix, an angle-dependent luminance indicatrix, and a distance-dependent and angle-dependent luminance indicatrix.

3. The method according to claim 2, further comprising the steps of determining the luminance indicatrix in a serial manner, with the display component being selected by the display and subsequently moving at least one camera in a defined manner across the area of the display, time-sequentially registering and storing a series of perspective-dependent luminances of the selected display area.

4. The method according to claim 2, further comprising the step of determining the luminance indicatrix in a parallel manner, with the display component being selected by the display, and a camera array covering several viewing perspectives registering and storing a series of perspective-dependent luminances of the selected display area essentially simultaneously.

5. The method according to claim 1, further comprising the step of determining the luminance indicatrix of the display component in a combined manner both parallel and serially.

6. The method according to claim 1, further comprising the step of measuring and storing an entire set of luminance indicatrices for each further display component.

7. The method according to claim 1, further comprising the steps of assigning image portions of the perspective views of the three-dimensional image original display portions with portion-wise corresponding perspective-dependent luminance indicatrices and displaying said image portions by these display portions.

8. The method according to claim 7, further comprising the step of generating an assignment specification in the form of a combination table on the basis of the parameters of the measured luminance indicatrices, luminance or contrast ratios, viewing distances, observation angles, direction-dependent contrast, and similar values, with a parameter-dependent assignment of the display portions to individual perspective views of the three-dimensional image original being established by means of the combination table and executed.

9. The method according to claim 8, further comprising the step of managing an entire set of combination tables assigned to different viewing positions by the assignment unit, with an adjustment to a variable position of the observer being made by the selection of a suitable combination table.

10. The method according to claim 9, further comprising the step of effecting the selection of the suitable combination table interactively, with the position of an observer, his or her head and/or eye position being detected and the detected position being converted into a selection parameter for the combination table to be selected.

11. The method according to claim 1, further comprising the step of making an optional specification of a direction-selective element in at least one perspective view, with the direction-selective element being adapted to a criterion selected from the group consisting of the pattern of the perspective view, its contour, partial sections with a certain display-specific luminance variance, a given viewing position, and a combination of two or more of said criteria.

12. The method according to claim 1, further comprising the step of generating a direction dependency for at least one display portion with insufficient perspective-dependent luminance indicatrices by using a direction-selective element assigned to the respective display portion.

13. The method according to claim 1, wherein the perspective-dependent luminance comprises a brightness value which is dependent on the perspective.

14. The method according to claim 1, wherein the perspective-dependent luminance comprises a perspective-dependent chromaticity or wavelength.

15. The method according to claim 1, wherein the perspective-dependent luminance comprises a brightness value which is dependent on the perspective and a chromaticity which is dependent on the perspective.

16. An arrangement for executing a method for the autostereoscopic representation of a stereoscopic image original which is displayed on a display means, according to claim 1, having at least the following system components:
a display unit with a distance-dependent and angle-dependent luminance characteristic,
an image analysis unit for registering display-specific angle-dependent and/or distance-dependent luminance values of the display unit,
a storage unit for measured luminance indicatrices, and
a comparator and assignment unit for the stored luminance indicatrices and perspective views of the stereoscopic image original.

17. The arrangement according to claim 16, wherein the image analysis unit comprises at least one camera which is arranged at a defined distance from the display surface and movable between at least two given positions and which serially receives the light from a momentarily activated portion of the display unit.

18. The arrangement according to claim 16, wherein the image analysis unit is constituted by a camera array comprising at least two cameras which are stationary with respect to the display and operated in parallel.
